(19) United States
(12) Patent Application Publication
(10) Pub. No.: US 2024/0093014 A1
(43) Pub. Date: Mar. 21, 2024

(54) POLYPROPYLENE COMPOSITION HAVING LOW SIT

(71) Applicant: Basell Poliolefine Italia S.r.l., Milano (IT)

(72) Inventors: Paola Massari, Ferrara (IT); Andrea Felisati, Ferrara (IT); Claudio Cavalieri, Ferrara (IT); Monica Galvan, Ferrara (IT); Michele Grazzi, Ferrara (IT)

(73) Assignee: Basell Poliolefine Italia S.r.l., Milano (IT)

(21) Appl. No.: 18/272,409

(22) PCT Filed: Dec. 2, 2021
(86) PCT No.: PCT/EP2021/084064

§ 371 Date: Jul. 14, 2023

(30) Foreign Application Priority Data
Jan. 14, 2021 (EP) 21151604.2

(51) Int. Cl. C08L 23/14; B32B 27/08; B32B 27/32; C08J 5/18

(52) U.S. Cl. CPC C08L 23/142; B32B 27/08; B32B 27/32; C08J 5/18; B32B 2250/02; B32B 2250/242; B32B 2270/00; B32B 2307/518; B32B 2307/546; B32B 2553/00; C08J 2323/14; C08J 2423/20; C08L 2203/16; C08L 2205/025

(57) ABSTRACT

A polymer composition made from or containing:
A) from 70 wt % to 95 wt % of a propylene polymer composition made from or containing:
   A1) from 15 wt % to 35 wt % of a propylene 1-butene copolymer; and
   A2) from 65 wt % to 85 wt % of a propylene ethylene 1-butene terpolymer; and
B) from 5.0 wt % to 30.0 wt % of a copolymer of 1-butene and ethylene containing from 3.0 wt % to 4.2 wt % of ethylene derived units, based upon the total weight of the copolymer of 1-butene and ethylene, wherein the sum of the amounts of A) and B) being 100 wt %.

### FIELD OF THE INVENTION

In general, the present disclosure relates to the field of chemistry. More specifically, the present disclosure relates to polymer chemistry. In particular, the present disclosure relates to propylene compositions and films made therefrom.

### BACKGROUND OF THE INVENTION

In some instances, polypropylene compositions are used for making films in the packaging field and in the non-packaging field. In some instances, polypropylene compositions are used in food and non-food packaging applications.

In some instances, the packaging is used for hygienic items, textile articles, magazines, mailing films, secondary collation packaging, shrink packaging films and sleeves, stretch packaging films and sleeves, form-fill-seal packaging films for portioning various types of articles, and vacuum formed blisters. In some instances, the articles are bags, pouches, or sachets.

In some instances, form-fill-seal applications include packaging of peat and turf, chemicals, plastic resins, mineral products, food products, and small size solid articles.

As used herein, the term “flexible plastic packaging” includes plastic films for packaging.

In some instances, non-packaging items include synthetic clothing articles, medical and surgical films, films which are formed into flexible conveying pipes, membranes for isolation and protection in soil, building and construction applications, and films which are laminated with non-woven membranes.

### SUMMARY OF INVENTION

In a general embodiment, the present disclosure provides a polymer composition made from or containing:
A) from 70 wt % to 95 wt % of a propylene polymer composition made from or containing:
   A1) from 15 wt % to 35 wt % of a propylene 1-butene copolymer having a 1-butene derived units content ranging from 9.0 wt % to 15.0 wt %, based upon the total weight of the propylene 1-butene copolymer; and
   A2) from 65 wt % to 85 wt % of a propylene ethylene 1-butene terpolymer, wherein the sum of the amount of component A1) and A2) being 100 wt %;
wherein the propylene polymer composition A) having
   (i) an ethylene derived units content ranging from 0.5 wt % to 2.5 wt %, based upon the total weight of the propylene polymer composition;
   (ii) a 1-butene derived units content ranging from 10.0 wt % to 19.0 wt %, based upon the total weight of the propylene polymer composition; and
   (iii) a Melt Flow Rate: measured according to ISO 1133-2011—(190° C., 2.16 Kg) ranging from 1.0 to 15.5 g/10 min; and
B) from 5.0 wt % to 30.0 wt % of a copolymer of 1-butene and ethylene containing from 3.0 wt % to 4.2 wt % of ethylene derived units, based upon the total weight of the copolymer of 1-butene and ethylene,
wherein the copolymer of 1-butene and ethylene having
   (i) a Melt Flow Rate: measured according to ISO 1133-2011—(190° C., 2.16 Kg) ranging from 1.0 to 5.5 g/10 min;
   (ii) a Flexural modulus measured according to ISO 178 2010 ranging from 50 MPa to 250 MPa; and
   (iii) a melting temperature measured according to ISO 11357-2013 ranging from 83° C. to 108° C., form I,
wherein the sum of the amounts of A) and B) being 100 wt %.

### DETAILED DESCRIPTION OF THE INVENTION

In some embodiments, the present disclosure provides a polymer composition made from or containing:
A) from 70.0 wt % to 95.0 wt %, alternatively from 72.0 wt % to 93.0 wt %; alternatively from 74.0 wt % to 87.0 wt %, of a propylene polymer composition (A) made from or containing:
   A1) from 15 wt % to 35 wt %, alternatively from 19 wt % to 31 wt %, alternatively from 23 wt % to 28 wt %, of a propylene 1-butene copolymer having a 1-butene derived units content ranging from 9.0 wt % to 15.0 wt %, alternatively from 10.0 wt % to 14.0 wt %, alternatively from 10.5 wt % to 13.5 wt %, based upon the total weight of the propylene 1-butene copolymer; and
   A2) from 65 wt % to 85 wt %, alternatively from 69 wt % to 81 wt %, alternatively from 72 wt % to 77 wt %, of a propylene ethylene 1-butene terpolymer;
   wherein the sum of the amount of component A1) and A2) being 100 wt %;
wherein the propylene polymer composition A) having
   (i) an ethylene derived units content ranging from 0.5 wt % to 2.5 wt %, alternatively from 0.7 wt % to 1.9 wt %, alternatively from 0.8 wt % to 1.6 wt %, based upon the total weight of the propylene polymer composition;
   (ii) a 1-butene derived units content ranging from 10.0 wt % to 19.0 wt %, alternatively from 12.0 wt % to 16.0 wt %, alternatively from 13.0 wt % to 15.5 wt %, based upon the total weight of the propylene polymer composition; and
   (iii) a Melt Flow Rate: measured according to ISO 1133-2011—(190° C., 2.16 Kg) ranging from 1.0 to 15.5 g/10 min, alternatively from 3.1 to 12.2 g/10 min; alternatively from 3.4 to 8.1 g/10 min; and
B) from 5.0 wt % to 30.0 wt %; alternatively from 7.0 wt % to 28.0 wt %; alternatively from 13.0 wt % to 26 wt %, of a copolymer of 1-butene and ethylene containing from 3.0 wt % to 4.2 wt %; alternatively from 3.2 wt % to 4.0 wt %; alternatively from 3.3 wt % to 3.9 wt %, of ethylene derived units, based upon the total weight of the copolymer of 1-butene and ethylene,
wherein the copolymer of 1-butene and ethylene having:
   (i) a Melt Flow Rate: measured according to ISO 1133-2011—(190° C., 2.16 Kg) ranging from 1.0 to 5.5 g/10 min; alternatively from 2.1 to 4.8 g/10 min; alternatively from 2.4 to 4.1 g/10 min;
   (ii) a Flexural modulus measured according to ISO 178-2010 ranging from 50 MPa to 250 MPa; alternatively ranging from 80 MPa to 210 MPa; alternatively ranging from 92 MPa to 174 MPa; and
   (iii) a melting temperature measured according to ISO 11357-2013 ranging from 83° C. to 108° C., alternatively ranging from 84° C. to 103° C.; alternatively ranging from 88° C. to 100° C., form I,
wherein the sum of the amounts of A) and B) being 100 wt %.

In some embodiments, component A2) has ethylene derived units content ranging from 1.9 wt % to 4.8 wt %, based upon the total weight of the propylene ethylene 1-butene terpolymer, and 1-butene derived units content ranging from 5.1 wt % to 10.5 wt %, based upon the total weight of the propylene ethylene 1-butene terpolymer.

As used herein, the term “copolymer” refers to polymers containing two comonomers such as propylene and ethylene, 1-butene and ethylene, or propylene and 1-butene. As used herein, the term “propylene ethylene 1-butene terpolymer” refers to a polymer made from or containing propylene, ethylene, and 1-butene comonomers.

In some embodiments, the propylene polymer composition (A) is commercially available under the tradename Adsyl 6C 30 F from LyondellBasell.

In some embodiments, the copolymer of 1-butene and ethylene B) is commercially available under the tradename Koattro DP 8310M from LyondellBasell.

In some embodiments, the polymer composition of the present disclosure is prepared by mechanically blending component A) and component B).

In some embodiments, the polymer composition is used for the preparation of films, alternatively multilayer films having a sealing layer made from or containing the polymer composition.

In some embodiments, the present disclosure provides a film made from or containing the polymer composition. In some embodiments, the film is a multilayer film having a sealing layer made from or containing the polymer composition.

In some embodiments, the multilayer films have at least the sealing layer made from or containing polymer composition. In some embodiments, the remaining layers are formed from other materials. In some embodiments, the other layers are made from or containing a polymer selected from the group consisting of polypropylene homopolymers, polyethylene copolymers, EVA, and other polymers.

In some embodiments, the combination and number of the layers of the multilayer structure varies. In some embodiments, the number of layers is from 3 to 11 layers or even more, alternatively 3 to 9 layers, alternatively 3 to 7 layers, alternatively 3 to 5 layers. In some embodiments, the combinations are selected from the group consisting of C/B/A, C/B/C/B/A, and C/B/C/D/C/B/A, wherein at least one sealing layer A is made from or containing the polymer composition.

In some embodiments, the layers of the multilayer film are 3 or 5 wherein a sealing layer is made from or containing the polymer composition.

In some embodiments, the polymer composition is further made from or containing additives.

In some embodiments, the polymer composition is used as sealing layer in a multilayer film.

In some embodiments, the polymer composition has a seal initiation temperature (SIT) lower than 70° C., alternatively lower than 68° C. In some embodiments, the polymer composition has a hot tack at 120° C. higher than 450 g.

In some embodiments, the polymer composition consists essentially of components A) and B).

In some embodiments, component A) consists essentially of components A1) and A2).

As used herein, the term “consists essentially of” refers to the presence of specific further components, which components do not materially affect the essential characteristics of the compound or composition. In some embodiments, no further polymers are present in the polymer composition. In some embodiments, no further polyolefins are present in the polymer composition.

The following examples are given to illustrate but not limit the present disclosure.

### Examples

Melt Flow Rate: measured according to ISO 1133-2011 (230° C., 2.16 Kg or 190° C., 2.16 Kg).

Density was measured according to ISO 1183-2011.

The density of samples was measured according to ISO 1183-2011 (ISO 1183-2011 method A “Methods for determining the density of non-cellular plastics—Part 1: Immersion method, liquid pyknometer method and titration method”; Method A: Immersion method, for solid plastics (except for powders) in void-free form). Test specimens were taken from compression-molded plaques conditioned for 10 days before carrying out the density measure.

Flexural Modulus according to ISO 178-2010, and supplemental conditions according to ISO 1873-2012.

Melting Temperature (ISO 11357-2013)

The melting temperature TmI was the melting temperature attributable to the crystalline form I of the copolymer. To determine the TmI, the copolymer sample was melted and then cooled down to 20° C. with a cooling rate of 10° C./min., kept for 10 days at room temperature, and then subjected to differential scanning calorimetry (DSC) analysis by cooling to −20° C. and then heating to 200° C. with a scanning speed corresponding to 10° C./min. In this heating run, the peak in the thermogram was taken as the melting temperature (Tml).

Ethylene Content in a 1-Butene Ethylene Copolymer

The content of comonomers was determined by infrared spectroscopy by collecting the IR spectrum of the sample vs. an air background with a Fourier Transform Infrared spectrometer (FTIR). The instrument data acquisition parameters were:
purge time: 30 seconds minimum
collect time: 3 minutes minimum
apodization: Happ-Genzel
resolution: 2 cm⁻¹.

Sample Preparation—Using a hydraulic press, a thick sheet was obtained by compression molding about 1 gram of sample between two aluminum foils. A small portion was cut from this sheet to mold a film. The film thickness was set to have a maximum absorbance of the CH₂ absorption band recorded at ˜720 cm⁻¹ of 1.3 a.u. (% Transmittance>5%). Molding conditions were a temperature of 180±10° C. (356° F.) with a pressure around 10 kg/cm² (142.2 PSI) for about one minute. The pressure was then released. The sample was removed from the press and cooled to room temperature. The spectrum of pressed film sample was recorded in absorbance vs. wavenumbers (cm⁻¹). The following measurements were used to calculate ethylene (C₂) and 1-butene (C₄) contents:
a) Area (Aₜ) of the combination absorption bands between 4482 and 3950 cm⁻¹ which was used for spectrometric normalization of film thickness.
b) Area (A_{C2}) of the absorption band due to methylenic sequences (CH₂ rocking vibration) in the range 660 to 790 cm⁻¹ after a proper digital subtraction of an isotactic polypropylene (IPP) and a C₂C₄ standard spectra.
c) The factor of subtraction (FCR_{C4}) between the spectrum of the polymer sample and the C₂C₄ standard spectrum. The standard spectrum was obtained by digital subtraction of a linear polyethylene from a C₂C₄ copolymer, thereby extracting the C₄ band (ethyl group at ˜771 cm⁻¹).

The ratio A_{C2}/Aₜ was calibrated by analyzing standard ethylene-1-butene copolymer compositions, determined by NMR spectroscopy. To calculate the ethylene (C₂) and 1-butene (C₄) content, calibration curves were obtained by using standard samples of ethylene and 1-butene detected by ¹³C-NMR.

Calibration for ethylene—A calibration curve was obtained by plotting A_{C2}/Aₜ versus ethylene molar percent (% C2m), and the coefficient a_{C2}, b_{C2}, and c_{C2} were calculated from a “linear regression”.

Calibration for 1-butene—A calibration curve was obtained by plotting FCR_{C4}/Aₜ versus butane molar percent (% C₄m) and the coefficients a_{C4}, b_{C4}, and C_{C4} were calculated from a “linear regression”.

The spectra of the samples were recorded. The (Aₜ), (A_{C2}), and (FCR_{C4}) of the samples were calculated.

The ethylene content (% molar fraction C2m) of the sample was calculated as follows:

$$\% C 2 m = - {b}_{C 2} + \frac{\sqrt{{b}_{C 2}^{2} - 4 \cdot {a}_{C 2} \cdot ( {c}_{C 2} - \frac{{A}_{C 2}}{{A}_{t}} )}}{2 \cdot {a}_{C 2}}$$

The 1-butene content (% molar fraction C4m) of the sample was calculated as follows:

$$\% C 4 m = - {b}_{C 4} + \frac{\sqrt{{b}_{C 4}^{2} - 4 \cdot {a}_{C 4} \cdot ( {c}_{C 4} - \frac{{FCR}_{C 4}}{{A}_{t}} )}}{2 \cdot {a}_{C 4}}$$

a_{C4}, b_{C4}, c_{C4}, a_{C2}, b_{C2}, and c_{C2} are the coefficients of the two calibrations.

Changes from mol % to wt % were calculated by using molecular weights.

Determination of the Comonomer Content in Component A

The comonomers content was determined by infrared spectroscopy by collecting the IR spectrum of the sample vs. an air background with a Fourier Transform Infrared spectrometer (FTIR); the instrument data acquisition parameters were:
purge time: 30 seconds minimum
collect time: 3 minutes minimum
apodization: Happ-Genzel
resolution: 2 cm⁻¹.

Sample Preparation:

Using a hydraulic press, a thick sheet was obtained by pressing about 1 g of sample between two aluminum foils. A small portion was cut from the sheet to mold a film. The film thickness ranged between 0.02 and 0.05 cm (8-20 mils).

Pressing temperature was 180±10° C. (356° F.), and the pressure was about 10 kg/cm² (142.2 PSI).

After about 1 minute the pressure was released. The sample was removed from the press and cooled to room temperature.

The spectrum of a pressed film of the polymer was recorded in absorbance vs. wavenumbers (cm⁻¹). The following measurements were used to calculate ethylene and 1-butene content:
Area (At) of the combination absorption bands between 4482 and 3950 cm⁻¹ was used for spectrometric normalization of film thickness.
AC2 was the area of the absorption band between 750-700 cm⁻¹ after two consecutive spectroscopic subtractions of an isotactic, additive-free polypropylene spectrum and then of a standard spectrum of a 1-butene-propylene random copolymer in the range 800-690 cm⁻¹.
DC4 was the height of the absorption band at 769 cm⁻¹ (maximum value), after two consecutive spectroscopic subtractions of an isotactic, additive-free polypropylene spectrum and then of a standard spectrum of an ethylene-propylene random copolymer in the range 800-690 cm⁻¹.

To calculate the ethylene and 1-butene content. calibration straights lines for ethylene and 1-butene were obtained by using standard samples of ethylene and 1-butene.

Calibration of Ethylene:

Calibration straight line GC2 was obtained by plotting AC2/At versus ethylene molar percent (% C2m). The slope of GC2 was calculated from a linear regression.

Calibration of 1-Butene:

Calibration straight line GC4 was obtained by plotting DC4/At versus 1-butene molar percent (% C4m). The slope of GC4 was calculated from a linear regression.

Spectrum of the sample was recorded and then (At), (AC2), and (DC4) of the sample were calculated. The ethylene content (% molar fraction C2m) of the sample was calculated as follows:

$$\% C 2 m = \frac{1}{{G}_{C 2}} \cdot \frac{{A}_{C 2}}{{A}_{t}}$$

The 1-butene content (% molar fraction C4m) of the sample was calculated as follows:

$$\% C 4 m = \frac{1}{{G}_{C 4}} \cdot ( \frac{{A}_{C 4}}{{A}_{t}} - {I}_{C 4} )$$

The propylene content (molar fraction C3m) was calculated as follows:

C3m=100−% C4m−% C2m

The ethylene, 1-butene contents by weight were calculated as follows:

$$\% C 2 wt = 100 \cdot \frac{28 \cdot C 2 m}{( 56 \cdot C 4 m + 42 \cdot C 3 m + 28 \cdot C 2 m )}$$

$$\% C 4 wt = 100 \cdot \frac{56 \cdot C 4 m}{( 56 \cdot C 4 m + 42 \cdot C 3 m + 28 \cdot C 2 m )}$$

Seal Initiation Temperature (SIT)

Preparation of the Film Specimens

Some films with a thickness of 50 μm were prepared by extruding each test composition in a single screw Collin extruder (length/diameter ratio of screw 1:25) at a film drawing speed of 7 m/min and a melt temperature of 210-250° C.

Each resulting film was superimposed on a 1000 μm thick film of a propylene homopolymer having a xylene insoluble fraction of 97 wt % and an MFR L of 2 g/10 min.

The superimposed films were bonded to each other in a Carver press at 200° C. under a 9000 kg load, which was maintained for 5 minutes.

The resulting laminates were stretched longitudinally and transversally, that is, biaxially, by a factor of 6 with a Karo 4 Brueckener film stretcher at 160° C., thereby obtaining a 20 μm thick film (18 μm homopolymer+2 μm test).

Determination of the SIT.

Film strips, 6 cm wide and 35 cm length, were cut from the center of the BOPP film. The film was superimposed with a BOPP film made of PP homopolymer. The superimposed specimens were sealed along one of the 2 cm sides with a Brugger Feinmechanik Sealer, model HSG-ETK 745. Sealing time was 5 seconds at a pressure of 0.14 MPa (20 psi). The starting sealing temperature was from about 10° C. less than the melting temperature of the test composition. The sealed strip was cut into 6 specimens 15 mm wide long enough to be held in the tensile tester grips. The seal strength 12 FE7234-EP-P1 was tested at a load cell capacity 100 N, cross speed 100 mm/min, and grip distance 50 mm. The results were expressed as the average of maximum seal strength (N). The unsealed ends were attached to an Instron machine wherein the sample specimens were tested at a traction speed of 50 mm/min.

The test was repeated by changing the temperature as follows:

If seal strength<1.5 N, then decrease the temperature. Temperature variation was adjusted stepwise. If seal strength was close to target, steps of 1C were selected. If the strength was far from target, steps of 2° C. were selected.

As used herein, the term “target seal strength (SIT)” refers to the lowest temperature at which a seal strength higher or equal to 1.5 N is achieved.

Determination of the Hot Tack

The hot tack measurement was determined after sealing by Brugger HSG Heat-Sealer (with Hot Tack kit). Samples obtained from BOPP film were cut at a minimum length of 200 mm and 15 mm width and tested at the following conditions:

The temperature was set from no sealing to 130° C. with an increase of 5° C. steps; at each temperature, set the weight to break the film in the neighborhood of the seal.

As used herein, a break of specimen occurred when 50% or more of the seal part was open after the impact.

Components A and B

Component A was commercially available under the tradename Adsyl 6C 30F from LyondellBasell. Component B was commercially available under the tradename Koattro DP 8310M from LyondellBasell.

The features of component A are reported in Table 1.

TABLE 1

| | | Component A |
|---|---|---|
| MFR | g/10 min | 5.5 |
| C4 content in A | wt % | 12.0 |
| amount A1 | wt % | 25 |
| C2 content total | wt % | 0.9 |
| C4 content total | wt % | 14.5 |

C2 = ethylene;
C4 1-butene

The features of component B are reported in Table 2.

TABLE 2

| | | Component B |
|---|---|---|
| MFR 190° C. 2.16 kg | g/10 min | 3.5 |
| Flexural modulus | MPa | 120 |
| Tm | ° C. | 94 |
| Ethylene content | Wt % | 3.7 |

Various amounts of component B were blended with component A. A two-layer BOPP film was produced for each blend. The two layers were made by the same component. The seal initiation temperature was measured. Table 3 reports the SIT for each sample.

TABLE 3

| Ex | Comp B | SIT ° C. |
|---|---|---|
| Comp 1 | 0 | 97 |
| 2 | 10 wt % | 67 |
| 3 | 15 wt % | 67 |
| 4 | 20 wt % | 65 |
| 5 | 25 wt % | 65 |

Comparative component AC was commercially available under the tradename Adsyl 5C 90F from LyondellBasell.

The features of component AC are reported in Table 4.

TABLE 4

| | | Component AC |
|---|---|---|
| MFR | g/10 min | 5.9 |
| C2 content in A1 | wt % | 3.2 |
| amount A1 | wt % | 35 |
| C2 content total | wt % | 3.2 |
| C4 content total | wt % | 6.6 |
| Tm | ° C. | 102 |

C2 = ethylene;
C4 1-butene

Various amounts of component AC were blended with component B. A two-layer BOPP film was produced for each blend. The two layers were made by the same component. The seal initiation temperature was measured. Table 5 reports the SIT for each sample.

TABLE 5

| ex | Comp B | SIT ° C. |
|---|---|---|
| Comp 6 | 0 | 102 |
| Comp 7 | 10 wt % | 76 |
| Comp 8 | 15 wt % | 68 |
| Comp 9 | 20 wt % | 68 |
| Comp 10 | 25 wt % | 68 |

Hot Tack

The hot tack of the films of example 4 and comparative example 9 was measured at various temperature. The results are reported in Table 6.

TABLE 6

| | Ex 4 | Comp ex 9 | Comp A |
|---|---|---|---|
| Temp ° C. | Hot tack g | Hot tack g | Hot tack g |
| 80 | 183 | 88 | — |
| 90 | 228 | 113 | 178 |
| 100 | 293 | 138 | 253 |
| 110 | 388 | 263 | 253 |
| 120 | 675 | 408 | 148 |

1. A polymer composition comprising:
A) from 70 wt % to 95 wt % of a propylene polymer composition comprising:
A1) from 15 wt % to 35 wt % of a propylene 1-butene copolymer having a 1-butene derived units content ranging from 9.0 wt % to 15.0 wt %, based upon the total weight of the propylene 1-butene copolymer; and
A2) from 65 wt % to 85 wt % of a propylene ethylene 1-butene terpolymer, wherein the sum of the amount of component A1) and A2) being 100 wt %;
wherein the propylene polymer composition A) having
(i) an ethylene derived units content ranging from 0.5 wt % to 2.5 wt %, based upon the total weight of the propylene polymer composition;
(ii) a 1-butene derived units content ranging from 10.0 wt % to 19.0 wt %, based upon the total weight of the propylene polymer composition; and
(iii) a Melt Flow Rate: measured according to ISO 1133-2011—(190° C., 2.16 Kg) ranging from 1.0 to 15.5 g/10 min; and
B) from 5.0 wt % to 30.0 wt % of a copolymer of 1-butene and ethylene containing from 3.0 wt % to 4.2 wt % of ethylene derived units, based upon the total weight of the copolymer of 1-butene and ethylene,
wherein the copolymer of 1-butene and ethylene having:
(i) a Melt Flow Rate: measured according to ISO 1133-2011—(190° C., 2.16 Kg) ranging from 1.0 to 5.5 g/10 min;
(ii) a flexural modulus measured according to ISO 178 ranging from 890-50 MPa to 250 MPa; and
(iii) a melting temperature measured according to Iso 11357-2013 ranging from 83° C. and 108° C., form I,
wherein the sum of the amounts of A) and B) being 100 wt %.

2. The polymer composition according to claim 1, wherein component A ranges from 72.0 wt % to 93.0 wt %; and component B) ranges from 7.0 wt % to 28.0 wt %.

3. The polymer composition according to claim 1, wherein:
Component A1 ranges from 19 wt % to 31 wt %; and
Component A2 ranges from 69 wt % to 81 wt %.

4. The polymer composition according to claim 1, wherein the copolymer of 1-butene and ethylene component B) contains from 3.2 wt % to 4.0 wt % of ethylene derived units, based upon the total weight of the copolymer of 1-butene and ethylene.

5. The polymer composition according to claim 1, wherein the copolymer of 1-butene and ethylene component B) has a Melt Flow Rate: measured according to ISO 1133-2011—(190° C., 2.16 Kg) ranging from 2.1 to 4.8 g/10 min.

6. The polymer composition according to claim 1, wherein component A1) has 1-butene derived units content ranging from 10.0 wt % to 14.0 wt %, based upon the total weight of the propylene 1-butene copolymer.

7. The polymer composition according to claim 1, wherein component A2) has ethylene derived units content ranging from 1.9 wt % to 4.8 wt %, based upon the total weight of the propylene ethylene 1-butene terpolymer, and 1-butene derived units content ranging from 5.1 wt % to 10.5 wt %, based upon the total weight of the propylene ethylene 1-butene terpolymer.

8. The polymer composition according to claim 1, wherein component A1) has a 1-butene derived units content ranging from 10.5 wt % to 13.5 wt %, based upon the total weight of the propylene 1-butene copolymer.

9. The polymer composition according to claim 1, wherein component A) has an ethylene derived units content ranging from 0.7 wt % to 1.9 wt %, based upon the total weight of the propylene polymer composition, and a 1-butene derived units content ranging from 12.0 wt % to 16.0 wt %, based upon the total weight of the propylene polymer composition.

10. The polymer composition according to claim 1, wherein the copolymer of 1-butene and ethylene component B) contains from 3.3 wt % to 3.9 wt % of ethylene derived units, based upon the total weight of the copolymer of 1-butene and ethylene.

11. The polymer composition according to claim 1, wherein the copolymer of 1-butene and ethylene component B) has a melting temperature measured according to ISO 11357-2013 ranging from 84° C. to 103° C., form I.

12. The polymer composition according to claim 1, wherein the copolymer of 1-butene and ethylene component B) has a flexural modulus measured according to ISO 178-2010 ranging from 80 MPa to 210 MPa.

13. The polymer composition according to claim 1, wherein component A) has a Melt Flow Rate: measured according to ISO 1133-2011 (190° C., 2.16 Kg) ranging from 3.1 to 12.2 g/10 min.

14. A film comprising the polymer composition of claim 1.

15. A multilayer film according to claim 14.
